(19) United States
(12) Patent Application Publication
(10) Pub. No.: US 2025/0079660 A1
(43) Pub. Date: Mar. 6, 2025

(54) BATTERY INCLUDING INTEGRATED TEMPERATURE PROBE

(71) Applicant: GM Global Technology Operations LLC, Detroit, MI (US)

(72) Inventors: Jing Gao, Rochester, MI (US); Anne Zhang, Troy, MI (US); Brian J. Koch, Berkley, MI (US); Xingcheng Xiao, Troy, MI (US); Zhe Li, Rochester, MI (US)

(21) Appl. No.: 18/461,792

(22) Filed: Sep. 6, 2023

(51) Int. Cl. H01M 50/569; B60L 50/64; G01K 1/02; G01K 3/02; H01M 10/48

(52) U.S. Cl. CPC H01M 50/569; B60L 50/64; G01K 1/026; G01K 3/02; H01M 10/486; B60L 58/24; H01M 2220/20

(57) ABSTRACT

A battery includes multiple stacked cells. Each cell includes an anode layer and a cathode layer separated by a permeable separator. At least one temperature probe structure is disposed on the permeable separator between the anode layer and the cathode layer of a first cell of the stacked cells. The temperature probe structure includes at least a first material partially coating the permeable separator and a second material partially coating the permeable separator. The first material overlaps with the second material at an overlap region. A first sensor output terminal is connected to the first material and a second sensor terminal is connected to the second material. A voltage differential between the first sensor output terminal and the second sensor output terminal corresponds to an average temperature of the overlap region.

### INTRODUCTION

The subject disclosure relates to battery pack temperature monitoring systems, and more specifically to an integrated temperature probe for monitoring the same.

Vehicles, including electric vehicles and hybrid electric vehicles include power storage and distribution systems that are configured to store electrical power received during charging operations and to distribute the stored electrical power to vehicle systems while the vehicle is being operated. One method of storing the electrical power is via stacked battery cells.

Charging and discharging operations, as well as ambient temperature fluctuations and heat from vehicle systems can affect the temperature of the battery cells. The temperature of the battery cells can impact the efficiency of the battery. Additionally, unexpected temperature changes can be indicative of faults or other undesirable operations.

Accordingly, it is desirable to provide an efficient and targeted system for monitoring battery temperatures within a stack of battery cells.

### SUMMARY

In one exemplary embodiment a battery includes a plurality of stacked cells, each cell comprising an anode layer and a cathode layer separated by a permeable separator, at least one temperature probe structure is disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material and, wherein a voltage differential between the first sensor output terminal and the second sensor output terminal corresponds to an average temperature of the overlap region.

In addition to one or more of the features described herein the battery comprises a plurality of temperature sensors, each temperature sensor in the plurality of temperature sensors being disposed in a distinct cell in the plurality of stacked cells.

In addition to one or more of the features described herein the overlap region of each temperature sensor is at a same coordinate position within each cell.

In addition to one or more of the features described herein the overlap region of each temperature sensor is at a distinct coordinate position within each cell.

In addition to one or more of the features described herein the first material has a coating thickness ranging from 50 nm to 500 nm and the second material has a coating thickness ranging from 50 nm to 500 nm.

In addition to one or more of the features described herein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.

In addition to one or more of the features described herein a metal foil contacts one of the first material and the second material, wherein the metal foil is one of embedded in and disposed on the one of the first material and the second material, and wherein the metal foil is a reference electrode.

In another exemplary embodiment a vehicle includes a propulsion system including at least one electric motor, a battery system connected to the propulsion system via a power distribution system, the battery system including at least one plurality of stacked cells, each cell in the plurality of stacked cells comprising an anode layer and a cathode layer separated by a permeable separator, at least one temperature probe structure disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material, and wherein a voltage differential between the first sensor output terminal and the second sensor output terminal corresponds to an average temperature of the overlap region, and a controller including at least one input connected to the first terminal and the second terminal, wherein the controller is configured to convert a voltage differential across the first terminal and the second terminal to a temperature.

In addition to one or more of the features described herein the at least one temperature probe structure comprises a plurality of temperature probe structures, each temperature probe structure in the plurality of temperature probe structures being disposed in a distinct cell in the plurality of stacked cells and wherein the controller is configured to determine a temperature map of the plurality of stacked cells.

In addition to one or more of the features described herein the overlap region of each temperature probe structure is at a same coordinate position within the corresponding cell as each other overlap region and the temperature map of the plurality of stacked cells defines a temperature gradient along the plurality of stacked cells.

In addition to one or more of the features described herein the overlap region of each temperature probe structure is at a distinct coordinate position within the corresponding cell from each other overlap region and the temperature map of the plurality of stacked cells defines a distributed temperature map.

In addition to one or more of the features described herein the first material has a coating thickness ranging from 50 nm to 500 nm and the second material has a coating thickness ranging from 50 nm to 500 nm.

In addition to one or more of the features described herein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.

In addition to one or more of the features described herein a metal foil contacts one of the first material and the second material, wherein the metal foil is one of embedded in and disposed on the one of the first material and the second material, and wherein the metal foil is a reference electrode.

In yet another exemplary embodiment a method for determining a cell stack temperature includes providing at least a first voltage potential difference between a first output terminal and a second output terminal to a controller, and converting the at least the first voltage potential difference to a temperature using the controller, wherein the first sensor terminal and the second sensor output are components of a temperature probe structure disposed on a permeable separator between an anode layer and a cathode layer of a first cell of a stacked cell, at least one temperature probe structure disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material.

In addition to one or more of the features described herein providing at least the first voltage potential difference between the first sensor output terminal and the second sensor output terminal to the controller, comprises providing multiple voltage potential difference to the controller and converting each of the multiple voltage potential differences to multiple temperatures with each provided voltage potential difference corresponding to a distinct temperature sensor within the stacked cell.

In addition to one or more of the features described herein the method further includes combining the multiple temperatures into a gradient measurement of a cell temperature.

In addition to one or more of the features described herein the method further includes combining the multiple temperatures into a point cloud measurement of a cell stack temperature.

In addition to one or more of the features described herein the first material has a coating thickness ranging from 50 nm to 500 nm and the second material has a coating thickness ranging from 50 nm to 500 nm.

In addition to one or more of the features described herein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including an electric propulsion motor;

FIG. 2 is a schematic representation of a battery cell according to one embodiment;

FIG. 3 is a schematic representation of a battery cell stack according to one embodiment;

FIG. 4 is a detailed schematic representation of a temperature probe separator for a battery cell;

FIG. 5A is a schematic representation of a temperature probe separator according to one example;

FIG. 5B is a schematic representation of a temperature probe separator according to another example;

FIG. 5C is a schematic representation of a temperature probe separator according to another example; and

FIG. 5D is a schematic representation of a temperature probe separator according to another example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. As used herein the term controller refers to any computerized control system including dedicated control systems, general vehicle controllers, control programs distributed across multiple systems, or any similar control architecture.

In accordance with an exemplary embodiment a battery system for a vehicle includes at least one battery comprising a set of stacked battery cells. A separator-like temperature probe is placed between electrode layers of a given cell without altering cell operation. The temperature probe enables measuring temperatures inside the cell stack, and can include targeted measurements of specific locations within the cell stack.

The temperature probe has a double-layer thin-film coating with two selective materials on one side of a separator. The two selective materials overlap at an overlap region and the voltage potential difference between the two materials, as measured across output terminals connected to each material, is related to the temperature. The particular relationship, and conversion, between the voltage potential difference and the temperature of the cell is dependent on known relationships between the selective materials used to form the probe. A controller is connected to output terminals, with each output terminal contacting only one of the selective materials. The voltage potential difference across the terminals is regressed using the known relationship to find the average temperature across the overlap region. The size and location of the overlap region on the separator provides for accurate targeting of the internal sensor measurements.

The temperature probe (the combination of the material layers and the separator layer on which the materials are disposed) is porous and permeable and is placed in a cell stack and can monitor the temperature from within the cell stack without interfering with cell operation. This sensor design provides flexibility allowing measurement at various locations within the stack, and the measurement is not reliant on external probes or estimations.

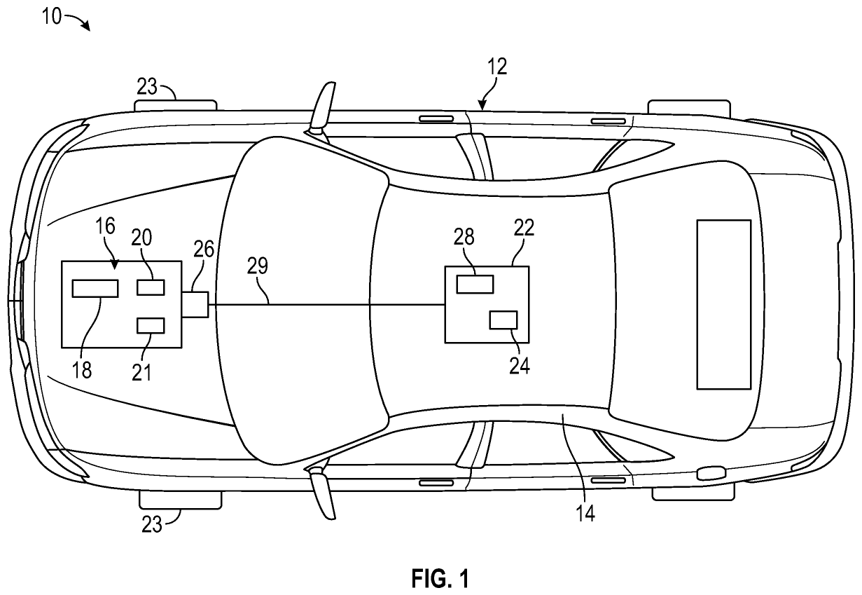

With continued reference to the general system described above, FIG. 1 shows an embodiment of a motor vehicle 10 including a battery system controller 24 configured to control a battery system. The vehicle 10 includes a vehicle body 12 defining, at least in part, an occupant compartment 14. The vehicle body 12 also supports various vehicle subsystems including a propulsion system 16, a battery system 22, other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. For example, the propulsion system 16 includes a first electric motor 20 and a second electric motor 21. The motors 20 and 21 may be configured to drive wheels 23 on opposing sides of the vehicle 10. Any number of motors positioned at various additional locations about the vehicle 10 may be used to provide mechanical rotation to corresponding systems and subsystems.

The battery system 22 may be electrically connected to the motors 20 and 21 and/or other components, such as vehicle electronics. The battery system 22 may be configured as a rechargeable energy storage system (RESS), and includes multiple battery cells partitioned into portions. A battery system controller 24 is included within the battery system 22 and controls the charging and discharging functions of the batteries within the battery system 22. In alternative configurations, the battery system controller 24 can be a general vehicle controller remote from the battery system 22 and configured to control multiple systems and/or subsystems. The general vehicle controller can be located at any position within the vehicle 10. In yet further alternatives, the battery system controller 24 can be a distributed control system including multiple coordinating controllers throughout the vehicle 10 encompassing controllers within the battery system 22 and controllers remote from the battery system 22.

In one embodiment, the battery system 22 includes one or more battery packs 28. The battery packs 28 include multiple distinct battery cells arranged in a stack. In the exemplary system of FIG. 1, the power distribution bus 29 is illustrated in simplified form and provides power to the propulsion systems 16 through an inverter 26.

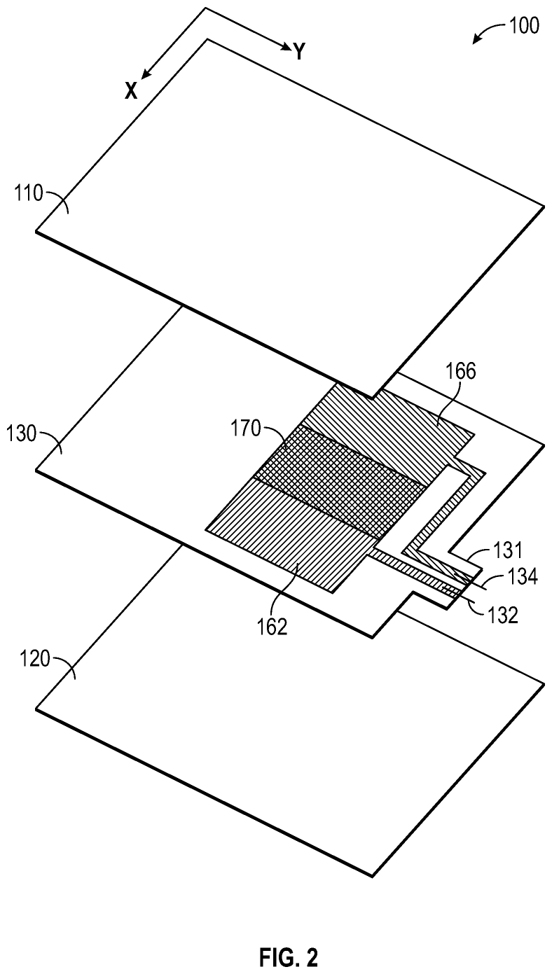

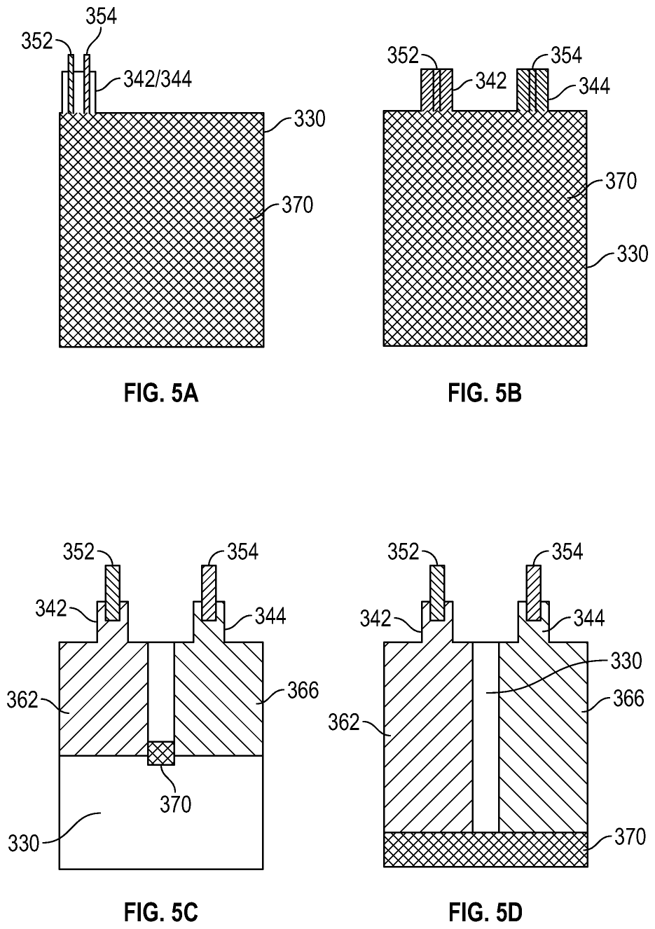

With continued reference to FIG. 1, FIG. 2 illustrates a simplified exemplary battery cell 100, such as could be used in the battery system 24. The exemplary cell 100 includes an anode layer 110 and a cathode layer 120. Positioned between the anode and cathode layers 110, 120 is a separator layer 130. The separator layer 130 is an electrically insulative material and includes a thermal probe structure including a first coating 162 disposed on a first side of the separator 130, a second coating 166 disposed on the first side of the separator 130, an overlap region 170 where the first coating 162 and the second coating 166 overlap each other, a tab 131 extending from the separator layer 130, and including portions of the first coating 162 and the second coating 164, and a pair of leads 132, 134 extending from the first coating 162, and the second coating 164 (respectively) with the leads 132, 134 being supported by the tab 131. In some examples, the separator layer 130 can include another layer of separator on top of the thermal probe structure, with the second layer of separator being substantially identical to the separator layer 130 and the separator layer 130 coating material being between the separator layer 130 and the second separator layer. The separator layer 130 is thin enough (in the range of 10 μm to 50 um) to be permeable and porous. Each coating material 162, 166 has a thickness in the range of 50 nm to 500 nm. The tab 131 extends beyond the circumferential edge of the separator layer 130. In alternative examples (See FIGS. 5B, 5C, 5D) each terminal 132, 134 can be on separate tabs resulting in two distinct tabs, each of which protrudes beyond the circumferential edge of the separator layer 130. While a practical implementation of the separator 130, the first coating layer 162 and the second coating layer 166 includes a third dimension of vertical thickness, the cell 100 can be considered to be a planar structure defined by an X-Y coordinate grid for ease of explanation, with the circumferential edge being the edges in the X-Y plane.

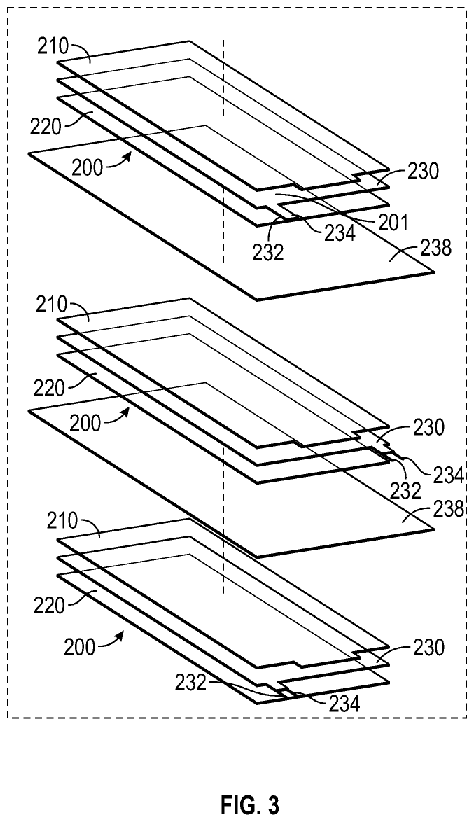

Each battery within the battery system 22 is made up of multiple battery cells 100. FIG. 3 illustrates an example stack of three battery cells 200, with each battery cell 200 including an anode layer 210 and a cathode layer 220, as in the example battery cell 100 of FIG. 2. The battery cells 200 are stacked with the cathode layer 220 of one battery cell 200 being adjacent the anode layer 210 of the next battery cell 200, with another separator 238 positioned between the battery cells 200. In the illustrated example, the separator layers 238 between battery cells 200 do not include temperature probe structures. Included within each of the battery cells 200 is a separator layer 230, including terminals 232, 234 arranged in the manner described with regards to FIG. 2. In an alternate embodiment the separator layer 230 can be in addition to a traditional separator layer.

The terminals 232, 234 and corresponding temperature prober structure (illustrated in FIG. 2) can be included in each battery cell 200, it is appreciated that a practical implementation of a battery system 24 can include any number of cells 200, with a subset of the cells 200 including the temperature probe structure. In such an example, the number of cells 200 including the temperature probe structure is generally limited to a number of inputs available in a corresponding controller.

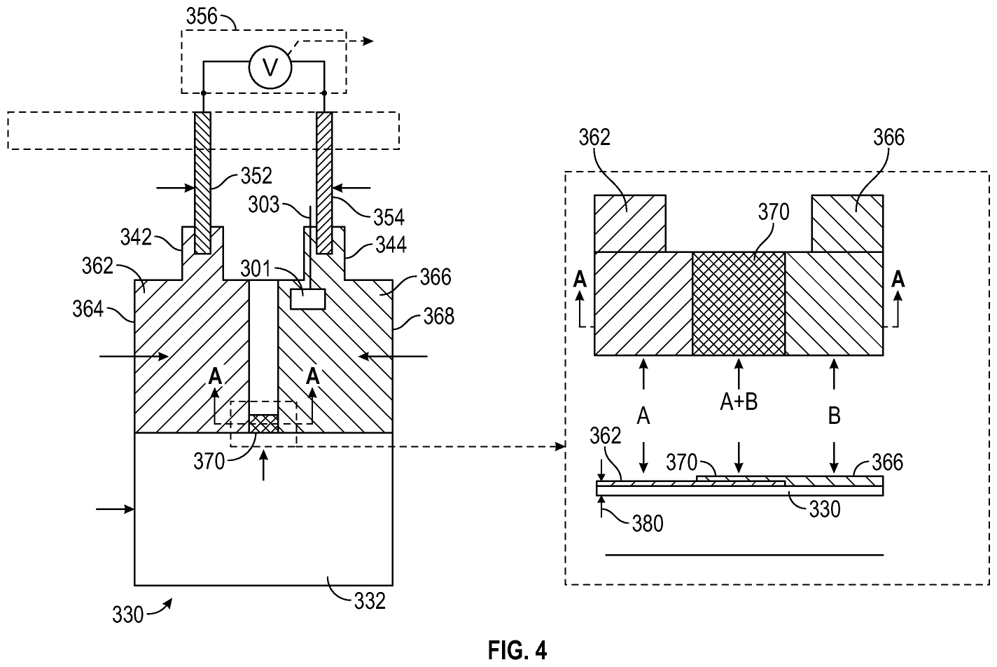

FIG. 4 schematically represents a more detailed example of a temperature probe structure, such as could be used in the battery cells 100, 200 of FIGS. 2 and 3 including a top view and a partial cross sectional view along cross section A-A. A separator 330 includes a porous permeable layer 332 that functions as the separator 130, 230 between the cathode layer 120, 220 and the anode layer 110, 210 of the corresponding cell 100, 300. Two tabs 342, 344 extend outward from the separator layer 332 and a corresponding output terminal 352, 354 is mounted to each tab 342, 344. Each terminal 352, 354 is connected to inputs of a controller 356, and the controller 356 measures the voltage potential difference between the terminals 352, 354 and converts the difference to a temperature value.

Disposed on the separator 330 is a first coating layer 362 covering a first area 364 and a second coating layer 366 covering a second area 368. The first area 364 and the second area include a shared overlapping region 370, where the coating layers 362, 366 overlap and contact each other. The first coating layer 362 extends onto a first tab 342 and the second coating layer 366 extends onto the second tab 344. The terminals 352, 354 on each tab 342, 344 contact the corresponding coating layers 262, 266. The coating layers 362, 366 are different materials and, in one example, are selected from the list of one of a Cu and Cu—Ni alloy, Ni—Al alloy, Ni—Cr Alloy, Fe, Ni—Si alloy, Pt, Pd, Pd-rare earth, and ceramic based materials. Each coating layer has a thickness 380 in the range of 50 nm to 500 nm. By using a thickness in the range of 50 nm too 500 nm, the coating layers 362, 366 do not reduce the porosity or permeability of the separator 330, and thus do not impair the energy storage and discharge functions of the cell 100, 200. In some examples, one or both of the coating layers 362, 366 can include a relatively small patch of metal foil 301, such as a lithium metal foil, deposited on one of the coating layers 362, 366 or embedded in one of the coating layers 362, 366. The patch of metal foil 301 is connected to a lead 303 supported on one of the tabs 342, 344 and is used as a reference electrode to provide a local voltage of the cathode layer 220 and anode layer 210 respectively to a controller in any known manner.

Due to the different materials of each layer 362, 366, a voltage potential difference exists between the two terminals 352, 354. The voltage potential difference is dependent on the average temperature across the overlap region 370. A controller 356 converts the voltage potential difference into a temperature reading at the overlap region 370 and provides the temperature reading(s) to any other control programs, controllers, and/or vehicle systems that may require or use the information.

It is appreciated that, as the voltage potential difference is the average temperature across the overlap area 370, different temperature measurements may be take depending on the positioning of the overlap region 370 within the cell 100, 200. The examples of FIGS, FIGS. 5A, 5B, 5C and 5D illustrate exemplary, non-limiting, variations on the positioning and size (by percentage of the separator 330) that is covered by the overlap region 370 according to some examples.

FIG. 5A illustrates an example, where the terminals 352, 354 are disposed on a shared tab 342/344, with each terminal 352, 354 only contacting one of the coating layers. In the example of FIG. 5A, the overlap region 370 covers all of the separator 330, and provides an average temperature reading of the entire cell 100, 200 in which the separator 330 of FIG. 5A is included. FIG. 5B illustrates a similar example to FIG. 5A, however each of the terminals 352, 354 is mounted to a distinct tab 342, 344 and the corresponding coating layers cover the entirety of the tabs 342, 344.

FIG. 5C provides an example having two tabs 342, 344 with each tab 342, 344 supporting one terminal 352, 354. Where the coating layers 362, 366 combined cover less than 50% of the separator 330, with each layer 362, 366 covering less than 30% of the surface. The overlap region 370 is disposed at a center point of the separator 330, and generates a point temperature reading at the center of the separator 330. It is further understood that similar point readings could be generated in similar constructions by locating the overlap region 370 at any point in the cell 100, 200 where a temperature reading is desired.

Inclusion of multiple separators 330 within a battery system 24, or multiple separators 330 within a single battery cell 100, 200, where the overlap regions 370 are in distinct places is used in some examples to provide a point map of temperature variation across the battery cell 100, 200 or battery system 24.

FIG. 5D illustrates an example where the overlap region 370 extends along a full edge of the separator 330, and is otherwise similarly constructed to the example of FIG. 5C.

It is appreciated that in some examples, a single battery system 24, or a single battery cell 100, 200, can utilize all or some of the illustrated variations and the variations are not mutually exclusive within a single battery. Further, it is appreciated that the combination of multiple different separators similar to those described in FIGS. 5A, 5B, 5C, and 5D can be used in conjunction with each other to create a three dimensional grid, or array, of temperature readings that can be converted by the controller into a gradient measurement across the individual cell 100, 200, or across an entire cell stack.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery comprising:
a plurality of stacked cells, each cell comprising an anode layer and a cathode layer separated by a permeable separator;
at least one temperature probe structure is disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material; and
wherein a voltage differential between the first sensor output terminal and the second sensor output terminal corresponds to an average temperature of the overlap region.

2. The battery of claim 1, wherein the battery comprises a plurality of temperature sensors, each temperature sensor in the plurality of temperature sensors being disposed in a distinct cell in the plurality of stacked cells.

3. The battery of claim 2, wherein the overlap region of each temperature sensor is at a same coordinate position within each cell.

4. The battery of claim 2, wherein the overlap region of each temperature sensor is at a distinct coordinate position within each cell.

5. The battery of claim 1, wherein the first material has a coating thickness ranging from 50 nm to 500 nm and the second material has a coating thickness ranging from 50 nm to 500 nm.

6. The battery of claim 1, wherein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.

7. The battery of claim 1, further comprising a metal foil contacting one of the first material and the second material, wherein the metal foil is one of embedded in and disposed on the one of the first material and the second material, and wherein the metal foil is a reference electrode.

8. A vehicle comprising:
a propulsion system including at least one electric motor;
a battery system connected to the propulsion system via a power distribution system, the battery system including at least one plurality of stacked cells, each cell in the plurality of stacked cells comprising an anode layer and a cathode layer separated by a permeable separator, at least one temperature probe structure disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material, and wherein a voltage differential between the first sensor output terminal and the second sensor output terminal corresponds to an average temperature of the overlap region; and
a controller including at least one input connected to the first terminal and the second terminal, wherein the controller is configured to convert a voltage differential across the first terminal and the second terminal to a temperature.

9. The vehicle of claim 8, wherein the at least one temperature probe structure comprises a plurality of temperature probe structures, each temperature probe structure in the plurality of temperature probe structures being disposed in a distinct cell in the plurality of stacked cells and wherein the controller is configured to determine a temperature map of the plurality of stacked cells.

10. The vehicle of claim 9, wherein the overlap region of each temperature probe structure is at a same coordinate position within the corresponding cell as each other overlap region and the temperature map of the plurality of stacked cells defines a temperature gradient along the plurality of stacked cells.

11. The vehicle of claim 9, wherein the overlap region of each temperature probe structure is at a distinct coordinate position within the corresponding cell from each other overlap region and the temperature map of the plurality of stacked cells defines a distributed temperature map.

12. The vehicle of claim 8, wherein the first material has a coating thickness ranging from 50 nm to 500 nm and the second material has a coating thickness ranging from 50 nm to 500 nm.

13. The vehicle of claim 8, wherein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.

14. The vehicle of claim 8, further comprising a metal foil contacting one of the first material and the second material, wherein the metal foil is one of embedded in and disposed on the one of the first material and the second material, and wherein the metal foil is a reference electrode.

15. A method for determining a cell stack temperature comprising:
providing at least a first voltage potential difference between a first output terminal and a second output terminal to a controller, and converting the at least the first voltage potential difference to a temperature using the controller, wherein the first sensor terminal and the second sensor output are components of a temperature probe structure disposed on a permeable separator between an anode layer and a cathode layer of a first cell of a stacked cell, at least one temperature probe structure disposed on the permeable separator between the anode layer and the cathode layer of a first cell of the stacked cells, the temperature probe structure comprising at least a first material partially coating the permeable separator and a second material partially coating the permeable separator, the first material overlapping with the second material at an overlap region, a first sensor output terminal connected to the first material and a second sensor terminal connected to the second material.

16. The method of claim 15, wherein providing at least the first voltage potential difference between the first sensor output terminal and the second sensor output terminal to the controller, comprises providing multiple voltage potential difference to the controller and converting each of the multiple voltage potential differences to multiple temperatures with each provided voltage potential difference corresponding to a distinct temperature sensor within the stacked cell.

17. The method of claim 16, further comprising combining the multiple temperatures into a gradient measurement of a cell temperature.

18. The method of claim 16, further comprising combining the multiple temperatures into a point cloud measurement of a cell stack temperature.

19. The method of claim 16, wherein the first material has a coating thickness ranging from 50 nm to 500 nm and the second material has a coating thickness ranging from 50 nm to 500 nm.

20. The method of claim 16, wherein the first material is one of a Cu and Cu—Ni alloy, Ni—Al alloy, Ni—Cr Alloy, Fe, Ni—Si alloy, Pt, Pd, Pd-rare earth, and ceramic material and the second material is another of Cu and Cu—Ni alloy, Ni—Al alloy, Ni—Cr Alloy, Fe, Ni—Si alloy, Pt, Pd, Pd-rare earth, ceramic material.
